(19) United States
(12) Patent Application Publication
(10) Pub. No.: US 2022/0121943 A1
(43) Pub. Date: Apr. 21, 2022

(54) METHOD AND DEVICE FOR AGGREGATING TASKS FOR EXECUTION BY CPU AND GPU DURING ARTIFICIAL INTELLIGENCE LEARNING, ELECTRONIC DEVICE USING METHOD, AND STORAGE MEDIUM

(71) Applicant: HON HAI PRECISION INDUSTRY CO., LTD., New Taipei (TW)

(72) Inventor: CHIEN-WU YEN, New Taipei (TW)

(21) Appl. No.: 17/506,630

(22) Filed: Oct. 20, 2021

(30) Foreign Application Priority Data
Oct. 20, 2020 (CN) 202011126557.1

(51) Int. Cl. G06N 3/08; G06F 9/48

(52) U.S. Cl. CPC G06N 3/08; G06F 9/485

(57) ABSTRACT

A processing method for artificial intelligence learning includes generates a directed graph including a number of first nodes according to a model. The model includes a number of tasks. The tasks represented by the first nodes are to be executed by a central processing unit (CPU) and a graphics processing unit (GPU). The method determines one or more second node sub-graphs formed by one or more second nodes of the first nodes which represent one or more tasks for execution by the GPU, and determines one or more directed acyclic sub-graphs in the one or more second node sub-graphs. The method merges into a single task at least two tasks represented by at least two second nodes in each directed acyclic sub-graph formed by at least two second nodes. A related electronic device and non-transitory storage medium are also provided.

### FIELD

The subject matter herein generally relates to data processing and particularly, to a method and a device for aggregating tasks for execution by CPU and GPU during artificial intelligence learning, an electronic device using the method, and a storage medium.

### BACKGROUND

Computer system commonly includes a number of processors, for example, a central processing unit (CPU) and a graphics processing unit (GPU). The GPU is configured to reduce the burden of processing on the CPU. During training a neural network model by a computer system, some tasks represented by some nodes can be executed by the CPU, and the other tasks represented by the other nodes can be executed by the GPU. When a task of the neural network model is executed by the GPU, the GPU should inform the CPU by means of an interrupt after finishing the instruction. According to the interrupt, the CPU can save data before the interrupt via one or more registers and a program counter. After finishing the interrupt, the GPU restores the data saved in the registers and the program counter and can continue processing the task before the interrupt. However, a lot of time and processing is carried out by the CPU in relation to the interrupt.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a block diagram of a first embodiment of a processing device for artificial intelligence learning.

FIG. 2 illustrates a flowchart of a second embodiment of a processing method for artificial intelligence learning.

FIG. 3 illustrates a schematic view of a directed graph including a number of first nodes, used in the method.

FIG. 4 illustrates an embodiment of the directed graph of the FIG. 3 including a second node sub-graph.

FIG. 5 illustrates the directed graph of FIG. 3 including two directed acyclic sub-graphs.

FIG. 6 illustrates a schematic view showing the tasks represented by the nodes in the directed graph of the FIG. 3 being gathered.

FIG. 7 illustrates the directed graph of FIG. 3 including a number of fourth nodes.

FIG. 8 illustrates another embodiment of the directed graph of FIG. 3 including a second node sub-graph.

FIG. 9 illustrates a block diagram of a third embodiment of an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, referencing the accompanying drawings, is illustrated by way of examples and not by way of limitation. It should be noted that references to “an” or “one” embodiment in this disclosure are not necessarily to the same embodiment, and such references mean “at least one.”

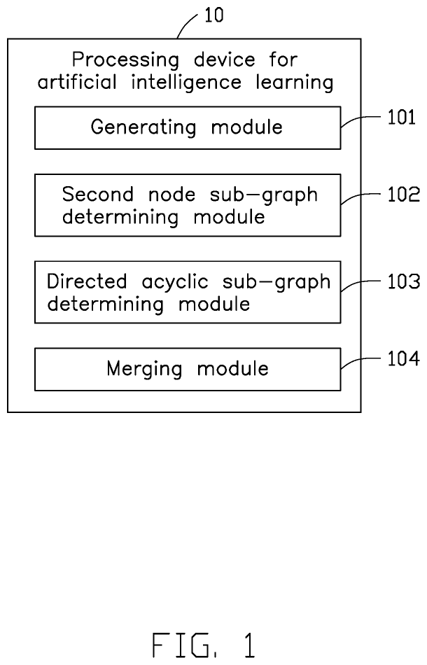

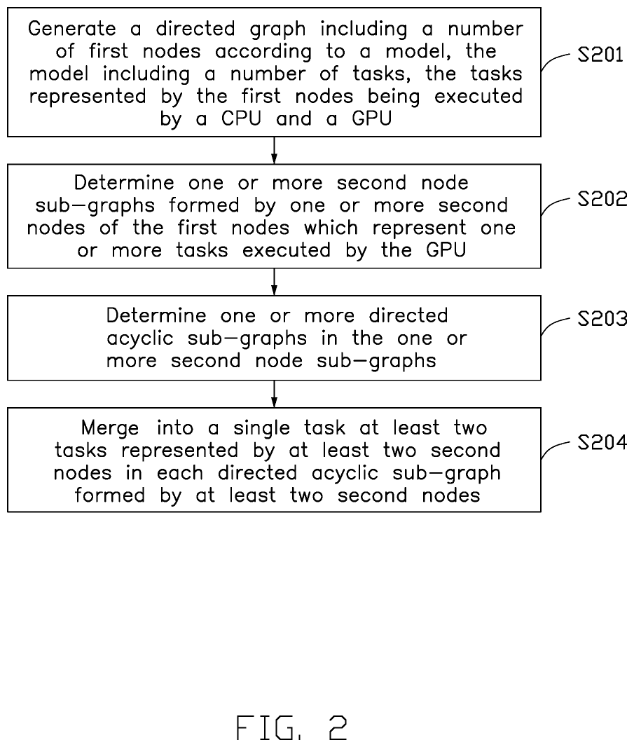

FIG. 1 illustrates a block diagram of a first embodiment of a processing device for artificial intelligence learning (hereinafter device 10). The device 10 can include a generating module 101, a second node sub-graph determining module 102, a directed acyclic sub-graph determining module 103, and a merging module 104. The generating module 101 is configured to generate a directed graph including a number of first nodes according to a model, the model including a number of tasks, the tasks represented by the first nodes being executed by a CPU and a GPU. The second node sub-graph determining module 102 is configured to determine one or more second node sub-graphs formed by one or more second nodes of the first nodes which represent one or more tasks executed by the GPU. The directed acyclic sub-graph determining module 103 is configured to determine one or more directed acyclic sub-graphs in the one or more second node sub-graphs. The merging module 104 is configured to merge at least two tasks represented by at least two second nodes in each directed acyclic sub-graph formed by at least two second nodes to a task. The modules 101-104 will be described with reference to a flowchart of a processing method for artificial intelligence learning in FIG. 2.

Referring to FIG. 2, FIG. 2 illustrates a flowchart of a second embodiment of a processing method for artificial intelligence learning. The processing method for artificial intelligence learning can be applied in an electronic device. The electronic device can be any device including a CPU and a GPU, for example, a computer system or a computer device. The processing method for artificial intelligence learning can begin at block S201.

At block S201, generating a directed graph including a number of first nodes according to a model, the model including a number of tasks, the tasks represented by the first nodes being executed by a CPU and a GPU.

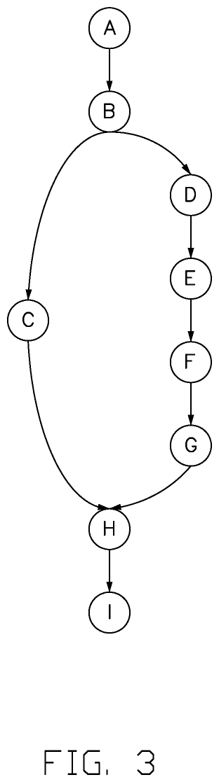

The model is a trained neural network model based on a frame, such as TensorFlow, MXNet, Caffe, Pytorch, or the like. Each first node can be a node, an instruction, or the like. In the embodiment, the method generates a directed graph including a number of first nodes according to a model in a sequence of executing tasks. The sequence of executing tasks includes a parallel executing sequence and a sequential executing sequence. For example, in FIG. 3, a task represented by a node C is a task c, a task represented by a node D is a task d, a task represented by a node E is a task e, thus a sequence between executing the task c and executing the task d is a parallel executing sequence, and a sequence between executing the task d and executing the task e is a sequential executing sequence. FIG. 3 shows a task represented by a node A, a task represented by a node H, and a task represented by a node I which are executed by the CPU. A task represented by a node B, the task represented by a node C, the task represented by a node D, the task represented by a node E, a task represented by a node F, and a task represented by a node G are executed by the GPU.

At block S202, determining one or more second node sub-graphs formed by one or more second nodes of the first nodes which represent one or more tasks executed by the GPU.

In the embodiment, determining one or more second node sub-graphs formed by one or more second nodes of the first nodes which represent one or more tasks executed by the GPU includes a step a1 and a step a2.

The step a1 includes determining one or more second nodes of the first nodes which represent one or more tasks executed by the GPU. For example, in FIG. 3, the second nodes of the first nodes which represent one or more tasks executed by the GPU includes the node B, the node C, the node D, the node E, the node F, and the node G.

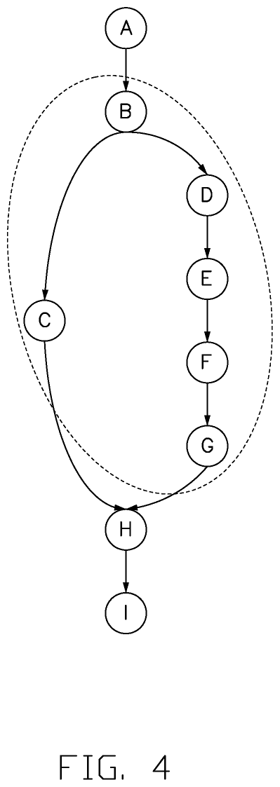

The step a2 includes gathering a number of third nodes existing in adjacent nodes in the executing sequence in the second nodes together with the adjacent nodes in the second nodes to form the one or more second node sub-graphs, where the executing sequence includes a parallel executing sequence and a sequential executing sequence. For example, in FIG. 3, an adjacent node in the parallel executing sequence existing between the node C and the node D is the node B. An adjacent node in the sequential executing sequence existing between the node B and the node E is the node D. An adjacent node in the sequential executing sequence existing between the node D and the node F is the node E. An adjacent node in the sequential executing sequence existing between the node E and the node G is the node F. Thus, the third nodes existing in adjacent nodes in the executing sequence in the second nodes and the adjacent nodes in the second nodes can be gathered to form the second node sub-graph, as circled by the dashed line as shown in FIG. 4.

At block S203, determining one or more directed acyclic sub-graphs in the one or more second node sub-graphs.

In the embodiment, determining one or more directed acyclic sub-graphs in the one or more second node sub-graphs includes a step b1 and a step b2. The step b1 includes determining one or more sequential nodes in the second node sub-graph. For example, in FIG. 4, the sequential nodes in the second node sub-graph include the node B to the node C and the node B to the nodes D, E, F, and G.

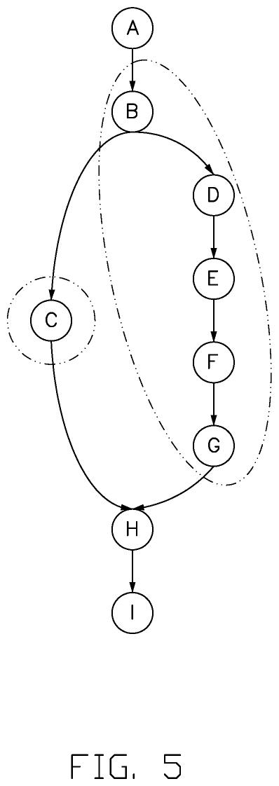

The step b2 includes determining one or more directed acyclic sub-graphs according to the sequential nodes. In the embodiment, the method determines one or more of the greatest directed acyclic sub-graphs according to the sequential nodes. For example, the two sequential nodes in the FIG. 4 both include the node B. However, the node B can be belonging to one directed acyclic sub-graph. Thus, the greatest directed acyclic sub-graphs determined according to the node B to the node C, and the node B to the nodes D, E, F, and G of the sequential nodes in FIG. 4 can be a directed acyclic sub-graph formed by the node C, and a directed acyclic sub-graph formed by the node B, and nodes D, E, F, and G can be as circled by dot-dash line as shown in FIG. 5.

In another embodiment, the method randomly determines one or more directed acyclic sub-graphs according to the sequential nodes. For example, the two sequential nodes in the FIG. 4 both include the node B. However, the node B can be belonging to one directed acyclic sub-graph. Thus, the directed acyclic sub-graphs determined according to the node B to the node C, and the node B to the nodes D, E, F, and G of the sequential nodes in FIG. 4 can be a directed acyclic sub-graph formed by the node B and the node C, and a directed acyclic sub-graph formed by the nodes D, E, F, and G.

At block S204, merging into a single task at least two tasks represented by at least two second nodes in each directed acyclic sub-graph formed by at least two second nodes.

In the embodiment, the method merges into a single task at least two tasks represented by at least two second nodes in each directed acyclic sub-graph formed by at least two second nodes according to a processing ability of the GPU. In the embodiment, merging into a single task at least two tasks represented by at least two second nodes in each directed acyclic sub-graph formed by at least two second nodes according to a processing ability of the GPU includes a step c1 and a step c2.

The step c1 includes partitioning the directed acyclic sub-graph including at least two second nodes to one or more sub-directed acyclic sub-graphs according to the processing ability of the GPU. For example, the processing ability of the GPU is three tasks. The step of partitioning of the directed acyclic sub-graph including at least two second nodes into one or more sub-directed acyclic sub-graphs according to the processing ability of the GPU can be, for example, partitioning the directed acyclic sub-graph including the nodes B, D, E, F, and G of the FIG. 5 into a sub-directed acyclic sub-graphs formed by the nodes B, D, and E, and a sub-directed acyclic sub-graphs formed by the nodes F and G.

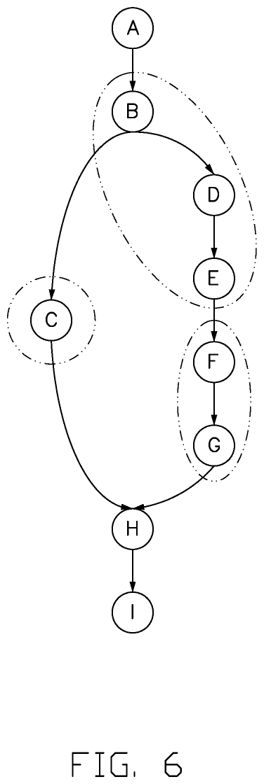

The step c2 includes merging into a single task at least two tasks represented by at least two second nodes in each sub-directed acyclic sub-graph formed by at least two second nodes. For example, merging at least two tasks represented by at least two second nodes in the sub-directed acyclic sub-graph formed by the nodes B, D, and E into a single task, and merging at least two tasks represented by at least two second nodes in the sub-directed acyclic sub-graph formed by the nodes F and G into a single task, as shown in FIG. 6. In FIG. 6, each graph circled by dotted double is the nodes representing a single task merged from the original tasks. Thus, while six tasks originally needed to be processed by the GPU, these can be merged into three tasks. Further, the original six interrupts needed to be processed by the CPU can be reduced to three interrupts.

In the embodiment, to reduce the number of interrupts needed to be processed by the CPU, the method further includes a step d1 and a step d2. The step d1 includes transmitting the merged tasks to the GPU to execute. The step d2 includes informing the CPU by an interrupt after the GPU finishes the merged tasks.

In another embodiment, determining one or more second node sub-graphs formed by one or more second nodes of the first nodes which represent one or more tasks executed by the GPU includes a step e1, a step e2, and a step e3. The step e1 includes determining one or more second nodes of the first nodes which represent one or more tasks executed by the GPU. For example, in FIG. 3, the second nodes of the first nodes which represent one or more tasks executed by the GPU include the nodes B, D, F, and G.

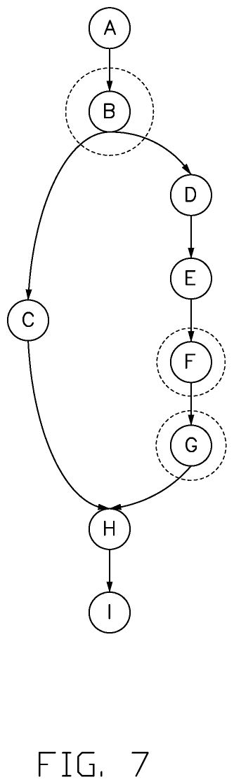

The step e2 includes determining one or more fourth nodes, these being the second nodes excepting one or more nodes that exist in another node in the executing sequence and which are not in the second node, where the executing sequence includes a parallel executing sequence and a sequential executing sequence. For example, in FIG. 3, a node C exists in the parallel executing sequence with the node D and but not in the second node. The fourth nodes are thus the second nodes except for one or more nodes that exist in another node not being the second node and includes the nodes B, F, and G as circled by the dashed line as shown in FIG. 7.

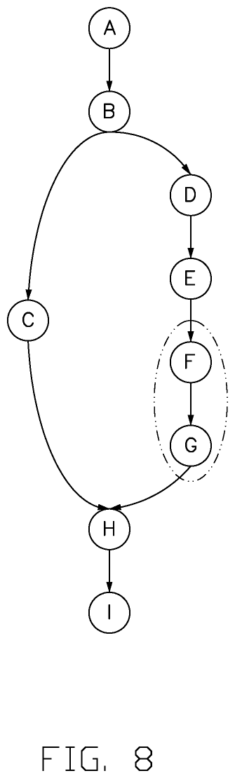

The step e3 includes gathering the nodes existing in a logical relation in the fourth nodes together to form a second node sub-graph, the nodes existing in a logical relation includes sequential nodes and parallel nodes. For example, in FIG. 7, the nodes F and G are sequential nodes, thus the nodes F and G can be gathered to form a second node sub-graph, as circled by dot-dash line as shown in FIG. 8. In this example, the directed acyclic sub-graph is the second node sub-graph in the FIG. 8.

The second embodiment generates a directed graph including a number of first nodes according to a model. The model includes a number of tasks, the tasks being represented by the first nodes, for execution by a CPU and a GPU. The second embodiment further determines one or more second node sub-graphs formed by one or more second nodes of the first nodes which represent one or more tasks for execution by the GPU, determines one or more directed acyclic sub-graphs in the one or more second node sub-graphs, and merges into a single task at least two tasks represented by at least two second nodes in each directed acyclic sub-graph formed by at least two second nodes. Thus, the disclosure enables the combining of sequential tasks for execution by the GPU, commuting (going back and forth) and looping are avoided, the number of interrupts needed to be processed by the CPU is accordingly reduced.

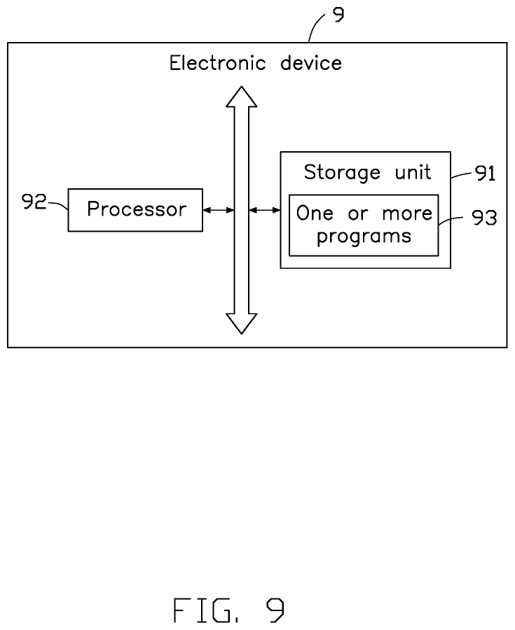

FIG. 9 illustrates a block diagram of a third embodiment of an electronic device. The electronic device 9 can include a storage unit 91, at least one processor 92, and one or more programs 93 stored in the storage unit 91 and programs 93 can be run on the at least one processor 92. The at least one processor 92 can execute the one or more programs 93 to accomplish the steps of the exemplary method. Alternatively, the at least one processor 92 can execute the one or more programs 93 to accomplish the functions of the modules of the exemplary device.

The one or more programs 93 can be divided into one or more modules/units. The one or more modules/units can be stored in the storage unit 91 and executed by the at least one processor 92 to accomplish the disclosed purpose. The one or more modules/units can be a series of program command segments which can perform specific functions, and the command segment is configured to describe the execution process of the one or more programs 93 in the electronic device 9. For example, the one or more programs 93 can be divided into modules as shown in the FIG. 1, details of the functions of each module are as in the first embodiment.

The electronic device 9 can be any suitable electronic device, for example, a personal computer, a tablet computer, a mobile phone, a PDA, or the like. A person skilled in the art knows that the device in FIG. 9 is only an example and is not to be considered as limiting of the electronic device 9, other examples of the electronic device 9 may include more or fewer parts, or may combine certain parts, or include different parts, such as including one or more buses, and so on.

The at least one processor 92 can be one or more central processing units, or it can be one or more other universal processors, digital signal processors, application specific integrated circuits, field-programmable gate arrays, or other programmable logic devices, discrete gate or transistor logic, discrete hardware components, and so on. The at least one processor 92 can be a microprocessor or the at least one processor 92 can be any regular processor or the like. The at least one processor 92 can be a control center of the electronic device 9, using a variety of interfaces and lines to connect various parts of the entire electronic device 9.

The storage unit 91 stores the one or more programs 93 and/or modules/units. The at least one processor 92 can run or execute the one or more programs and/or modules/units stored in the storage unit 91, call out the data stored in the storage unit 91 and accomplish the various functions of the electronic device 9. The storage unit 91 may include a program area and a data area. The program area can store an operating system, and applications that are required for the at least one function, such as sound playback features, image playback functions, and so on. The data area can store data created according to the use of the electronic device 9, such as audio data, and so on. In addition, the storage unit 91 can include a non-transitory storage medium, such as hard disk, memory, plug-in hard disk, smart media card, secure digital, flash card, at least one disk storage device, flash memory, or another non-transitory storage medium.

If the integrated modules/units of the electronic device 9 are implemented in the form of or by means of a software functional unit and the software is an independent product as sold or used, all parts of the integrated module/unit of the electronic device 9 may be stored in a computer-readable storage medium. The electronic device 9 can use one or more programs to control the related hardware to accomplish all parts of the method of this disclosure. The one or more programs can be stored in a computer-readable storage medium. The one or more programs can accomplish the blocks of the exemplary method when executed by the at least one processor. The one or more stored programs can include program code. The program code can be in the form of source code, object code, executable code file, or code in some intermediate form. The computer-readable storage medium may include any entity or device capable of recording and carrying the program codes, recording media, USB flash disk, mobile hard disk, disk, computer-readable storage medium, and read-only memory.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A processing method for artificial intelligence learning, comprising:
generating a directed graph including a plurality of first nodes according to a model, the model including a plurality of tasks, the tasks represented by the first nodes being executed by a central processing unit and a graphics processing unit;
determining one or more second node sub-graphs formed by one or more second nodes of the first nodes which represent one or more tasks executed by the graphics processing unit;
determining one or more directed acyclic sub-graphs in the one or more second node sub-graphs;
merging into a single task at least two tasks represented by at least two second nodes in each directed acyclic sub-graph formed by at least two second nodes.

2. The method according to claim 1, wherein generating a directed graph including a plurality of first nodes according to a model comprises:
generating a directed graph including a plurality of first nodes according to a model in a sequence of executing tasks.

3. The method according to claim 1, wherein determining one or more second node sub-graphs formed by one or more second nodes of the first nodes which represent one or more tasks executed by the graphics processing unit comprises:
determining one or more second nodes of the first nodes which represent one or more tasks executed by the graphics processing unit;
gathering a plurality of third nodes existing in one or more adjacent nodes in the executing sequence in the second nodes together with the one or more adjacent nodes in the second nodes to form the one or more second node sub-graphs, where the executing sequence including a parallel executing sequence and a sequential executing sequence.

4. The method according to claim 1, wherein determining one or more directed acyclic sub-graphs in the one or more second node sub-graphs comprises:
determining one or more sequential nodes in the second node sub-graph;
determining one or more directed acyclic sub-graphs according to the sequential nodes.

5. The method according to claim 1, wherein merging into a single task at least two tasks represented by at least two second nodes in each directed acyclic sub-graph formed by at least two second nodes comprises:
merging into a single task at least two tasks represented by at least two second nodes in each directed acyclic sub-graph formed by at least two second nodes according to a processing ability of the graphics processing unit.

6. The method according to claim 5, wherein merging into a single task at least two tasks represented by at least two second nodes in each directed acyclic sub-graph formed by at least two second nodes according to a processing ability of the graphics processing unit comprises:
partitioning the directed acyclic sub-graph including at least two second nodes to one or more sub-directed acyclic sub-graphs according to the processing ability of the graphics processing unit;
merging into a single task at least two tasks represented by the at least two second nodes in each sub-directed acyclic sub-graph formed by at least two second nodes.

7. The method according to claim 1, wherein the method further comprises:
transmitting the merged tasks to the graphics processing unit to execute;
informing the central processing unit by an interrupt after the graphics processing unit finishes the merged tasks.

8. An electronic device comprising:
a storage device;
at least one processor; and
the storage device storing one or more programs, which when executed by the at least one processor, cause the at least one processor to:
generate a directed graph including a plurality of first nodes according to a model, the model including a plurality of tasks, the tasks represented by the first nodes being executed by a central processing unit and a graphics processing unit;
determine one or more second node sub-graphs formed by one or more second nodes of the first nodes which represent one or more tasks executed by the graphics processing unit;
determine one or more directed acyclic sub-graphs in the one or more second node sub-graphs;
merge into a single task at least two tasks represented by at least two second nodes in each directed acyclic sub-graph formed by at least two second nodes.

9. The electronic device according to claim 8, further causing the at least one processor to:
generate a directed graph including a plurality of first nodes according to a model in a sequence of executing tasks.

10. The electronic device according to claim 8, further causing the at least one processor to:
determine one or more second nodes of the first nodes which represent one or more tasks executed by the graphics processing unit;
gather a plurality of third nodes existing in one or more adjacent nodes in the executing sequence in the second nodes together with the one or more adjacent nodes in the second nodes to form the one or more second node sub-graphs, where the executing sequence including a parallel executing sequence and a sequential executing sequence.

11. The electronic device according to claim 8, further causing the at least one processor to:
determine one or more sequential nodes in the second node sub-graph;
determine one or more directed acyclic sub-graphs according to the sequential nodes.

12. The electronic device according to claim 8, further causing the at least one processor to:
merge into a single task at least two tasks represented by at least two second nodes in each directed acyclic sub-graph formed by at least two second nodes according to a processing ability of the graphics processing unit.

13. The electronic device according to claim 12, further causing the at least one processor to:
partition the directed acyclic sub-graph including at least two second nodes to one or more sub-directed acyclic sub-graphs according to the processing ability of the graphics processing unit;
merge into a single task at least two tasks represented by the at least two second nodes in each sub-directed acyclic sub-graph formed by at least two second nodes.

14. The electronic device according to claim 8, further causing the at least one processor to:
transmit the merged tasks to the graphics processing unit to execute;
inform the central processing unit by an interrupt after the graphics processing unit finishes the merged tasks.

15. A non-transitory storage medium storing a set of commands, when the commands being executed by at least one processor of an electronic device, causing the at least one processor to:
generate a directed graph including a plurality of first nodes according to a model, the model including a plurality of tasks, the tasks represented by the first nodes being executed by a central processing unit and a graphics processing unit;
determine one or more second node sub-graphs formed by one or more second nodes of the first nodes which represent one or more tasks executed by the graphics processing unit;
determine one or more directed acyclic sub-graphs in the one or more second node sub-graphs;
merge into a single task at least two tasks represented by at least two second nodes in each directed acyclic sub-graph formed by at least two second nodes.

16. The non-transitory storage medium according to claim 15, further causing the at least one processor to:
generate a directed graph including a plurality of first nodes according to a model in a sequence of executing tasks.

17. The non-transitory storage medium according to claim 16, further causing the at least one processor to:
determine one or more second nodes of the first nodes which represent one or more tasks executed by the graphics processing unit;
gather a plurality of third nodes existing in one or more adjacent nodes in the executing sequence in the second nodes together with the one or more adjacent nodes in the second nodes to form the one or more second node sub-graphs, where the executing sequence including a parallel executing sequence and a sequential executing sequence.

18. The non-transitory storage medium according to claim 17, further causing the at least one processor to:
determine one or more sequential nodes in the second node sub-graph;
determine one or more directed acyclic sub-graphs according to the sequential nodes.

19. The non-transitory storage medium according to claim 15, further causing the at least one processor to:
merge into a single task at least two tasks represented by at least two second nodes in each directed acyclic sub-graph formed by at least two second nodes according to a processing ability of the graphics processing unit.

20. The non-transitory storage medium according to claim 19, further causing the at least one processor to:
partition the directed acyclic sub-graph including at least two second nodes to one or more sub-directed acyclic sub-graphs according to the processing ability of the graphics processing unit;
merge into a single task at least two tasks represented by the at least two second nodes in each sub-directed acyclic sub-graph formed by at least two second nodes.
